(19) United States
(12) Patent Application Publication
(10) Pub. No.: US 2025/0246857 A1
(43) Pub. Date: Jul. 31, 2025

(54) SOCKET AND ELECTROMAGNETIC SHIELDING ASSEMBLY

(71) Applicant: Delta Electronics, Inc., Taoyuan City (TW)

(72) Inventors: Hung-Chuan Chen, Taoyuan City (TW); Kuo-Hua Lin, Taoyuan City (TW); Pei-Hsuan Hu, Taoyuan City (TW)

(21) Appl. No.: 18/647,211

(22) Filed: Apr. 26, 2024

(30) Foreign Application Priority Data
Jan. 29, 2024 (CN) 202410117205.1

(51) Int. Cl. H01R 13/6597; H01R 13/6581

(52) U.S. Cl. CPC H01R 13/6597; H01R 13/6581

(57) ABSTRACT

A socket for using in a power supply is disclosed, wherein the power supply includes a housing and at least one contact plate. The at least one contact plate is bent and extended inwardly from the housing for contacting with the socket to form an electromagnetic shielding assembly. The socket includes a main body, a shielding layer and a conductive component. The main body has a first opening and a receptacle, and the receptacle is communicated with the first opening. The shielding layer covers at least one side of the main body and has at least one protrusion for contacting the at least one contact plate. The conductive component passes through the main body correspondingly and is partially disposed in the receptacle.

### CROSS-REFERENCE TO RELATED APPLICATION

This application claims priority to China Patent Application No. 202410117205.1, filed on Jan. 29, 2024. The entire contents of the above-mentioned applications are incorporated herein by reference for all purposes.

### FIELD OF THE INVENTION

The present disclosure relates to a socket and an electromagnetic shielding assembly, and more particularly to a socket and an electromagnetic shielding assembly for using in a power supply, and can be in contact with each other through the shielding layer on the socket and the inwardly bent contact plate of the housing of the power supply, so as to achieve electromagnetic shielding and conduction effects.

### BACKGROUND OF THE INVENTION

With increasing development of science and technology, a variety of electrical appliances are frequently used. As known, power supply is necessary for normal operation of the electrical appliance. In various electrical appliances, through the cooperation of the power supply connectors, such as plugs and sockets, the AC power can be converted into DC power, so as to provide power for the operation of the electrical appliance.

Please refer to FIG. 1 and FIG. 2. FIG. 1 is a schematic perspective view illustrating a power supply of the prior art. FIG. 2 is a schematic rear view illustrating a socket of the power supply of the prior art. As shown in FIG. 1, the conventional power supply 1 includes a housing 10, the housing 10 is composed of a plurality of plates assembled together, and has an accommodating space (not shown) inside, so as to accommodate a plurality of electronic components (not shown). There is an opening 12 disposed on the back plate 11 of the housing 10, so that the socket 2 can pass through the opening 12 and engage within the opening 12. As shown in FIG. 2, the conventional socket 2 includes a main body 20 and a shielding layer 22. The shielding layer 22 covers the upper surface 20a of the main body 20 and has a contact portion 22a. In the prior art, the contact portion 22a of the shielding layer 22 is a long flange structure, which extends upward from the side of the first surface 22b of the shielding layer 22 and is attached to the inner surface 21a of the frame 21 of the socket 2. When the socket 2 is correspondingly disposed in the housing 10 of the power supply 1, the contact portion 22a attached to the inner surface 21a of the frame 21 can correspondingly contact the back plate 11 of the housing 10. In this circumstance, through the electrical connection between the contact portion 22a and the back plate 11, the electromagnetic interference (EMI) can be conducted outward to achieve the effect of shielding electromagnetic interference (EMI).

Since the contact portion 22a is a single elongated flange structure, the contact area between the contact portion 22a and the back plate 11 is small. Moreover, due to repeated insertion of the plug for a long period of time, the socket 2 may become loose or slide and shift, resulting in a gap between the socket 2 and the back plate 11 of the housing 10, so that the socket 2 and the back plate 11 cannot be in close contact. Consequently, it is difficult to ensure the stable electrical connection between the contact portion 22a and the back plate 11, so it is easy to cause the poor contact problem, thereby affecting the stability and service life of the product.

Therefore, there is a need of providing a socket and an electromagnetic shielding assembly to obviate the drawbacks encountered from the prior arts.

### SUMMARY OF THE INVENTION

It is an object of the present disclosure to provide a socket for using in a power supply. At least one protrusion is arranged on the shielding layer of the socket, and each protrusion has a first contact surface. Through the contact manners between the first contact surface of the at least one protrusion and at least one second contact surface of the contact plate bent inwardly from the housing of the power supply, multi-point contact and a larger contact area are achieved. Consequently, the efficiency of shielding electromagnetic interference (EMI) and conducting EMI outwardly is increased.

It is another object of the present disclosure to provide an electromagnetic shielding assembly for using in a power supply. The electromagnetic shielding assembly is composed of a shielding layer and at least one contact plate. Through the contact manners between the shielding layer of the socket and the contact plate bent inwardly from the housing of the power supply, so as to achieve electromagnetic shielding and conduction effects. At the same time, the contact strength between the shielding layer and the contact plate is enhanced, and the poor contact problem of the prior art can be solved, so that the beneficial of increasing the stability, performance and service life of the product are also achieved.

In accordance with an aspect of the present disclosure, there is provided a socket for using in a power supply, wherein the power supply includes a housing and at least one contact plate. The at least one contact plate is bent and extended inwardly from the housing for contacting with the socket to form an electromagnetic shielding assembly. The socket includes a main body, a shielding layer and a conductive component. The main body has a first opening and a receptacle, and the receptacle is communicated with the first opening. The shielding layer covers at least one side of the main body and has at least one protrusion for contacting the at least one contact plate. The conductive component passes through the main body and is partially disposed in the receptacle.

In an embodiment, the at least one protrusion is a plurality of elongated protruding ribs, and is disposed on at least one surface of the shielding layer.

In an embodiment, the at least one protrusion is at least one elastic piece, and is disposed on at least one surface of the shielding layer.

In an embodiment, the socket further includes a fixing frame which connects to the main body and is arranged around the first opening, and has an inner surface, and when the main body is correspondingly disposed in the housing of the power supply, the fixed frame corresponds to arrange on an outer surface of the housing.

In an embodiment, the main body includes a first side, a second side, a third side, a fourth side and a fifth side, wherein the first side is opposite to the second side and is connected to the third side and the fourth side, the third side is opposite to the fourth side and is connected to the first side and the second side, wherein one edges of the first side, the second side, the third side and the fourth side are respectively connected to the fixed frame and perpendicular to the inner surface of the fixed frame, and the opposite edges of the first side, the second side, the third side and the fourth side are respectively connected to the fifth side, and the fifth side is arranged to face the first opening.

In an embodiment, the conductive component includes a first terminal and a second terminal, wherein the first terminal is arranged in the receptacle, and the second terminal correspondingly penetrates the fifth side of the main body, and is protruded on the fifth side.

In an embodiment, the shielding layer covers the first side of the main body, and the at least one protrusion is correspondingly disposed on the shielding layer.

In an embodiment, the shielding layer covers the first side, the second side, the third side and the fourth side of the main body, and the at least one protrusion is correspondingly disposed on the shielding layer covering the first side and the second side.

In an embodiment, the at least one protrusion includes a plurality of triangular ribs disposed on at least one surface of the shielding layer, wherein one side of each triangular rib is correspondingly connected to the inner surface of the fixing frame, and a inclined surface of each triangular rib is diagonally extended from the inner surface to the at least one surface of the shielding layer.

In an embodiment, the shielding layer is made of a metal material.

In accordance with an aspect of the present disclosure, there is provided an electromagnetic shielding assembly. The electromagnetic shielding assembly includes a shielding layer and at least one contact plate. The shielding layer covers at least one side of a main body of a socket, and has at least one protrusion. Each protrusion has a first contact surface. The at least one contact plate is bent and extended inwardly from a housing of a power supply. When the socket is corresponding disposed in the housing of the power supply, the at least one first contact surface of the at least one protrusion is in contact with at least one second contact surface of the at least one contact plate.

In an embodiment, the at least one second contact surface is perpendicular to an inner surface of the housing.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a power supply of the prior art;

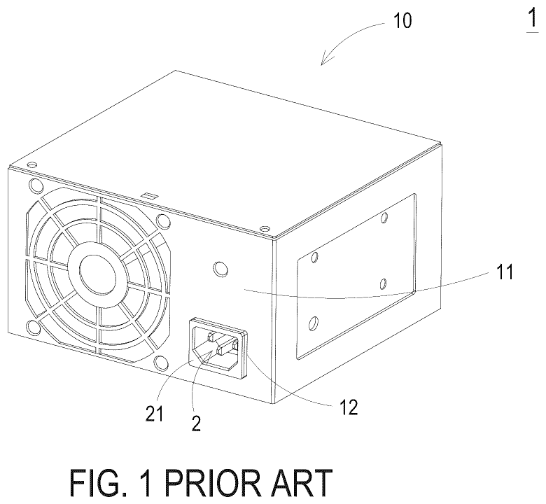

FIG. 2 is a schematic rear view illustrating a socket of the power supply of the prior art;

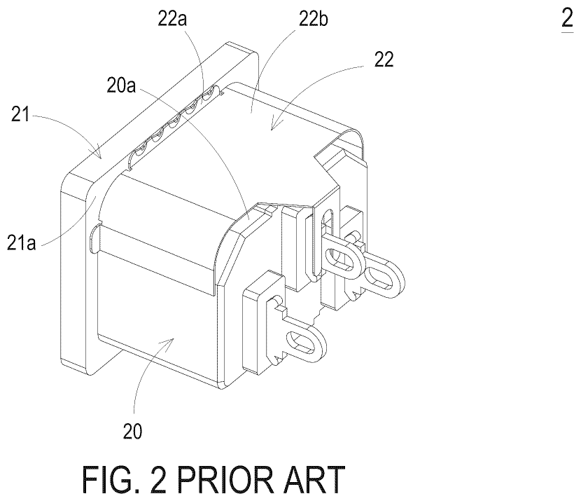

FIG. 3A is a schematic perspective view illustrating a socket and a housing of a power supply according to a first embodiment of the present disclosure;

FIG. 3B is a schematic rear view illustrating the socket and the housing of the power supply of FIG. 3A;

FIG. 3C is a schematic perspective view illustrating the power supply according to the first embodiment of the present disclosure;

FIG. 4 is a schematic perspective view illustrating the socket of FIG. 3B;

FIG. 5A is a schematic perspective view illustrating a socket and a housing of a power supply according to a second embodiment of the present disclosure;

FIG. 5B is a schematic bottom view illustrating the socket of FIG. 5A;

FIG. 6A is a schematic perspective view illustrating a socket according to a third embodiment of the present disclosure;

FIG. 6B is a schematic bottom view illustrating the socket of FIG. 6A;

FIG. 7A is a schematic perspective view illustrating a socket according to a fourth embodiment of the present disclosure; and

FIG. 7B is a schematic rear view illustrating the socket of FIG. 7A.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

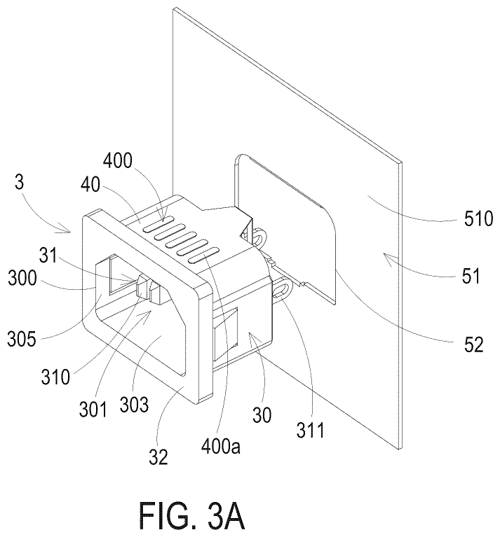

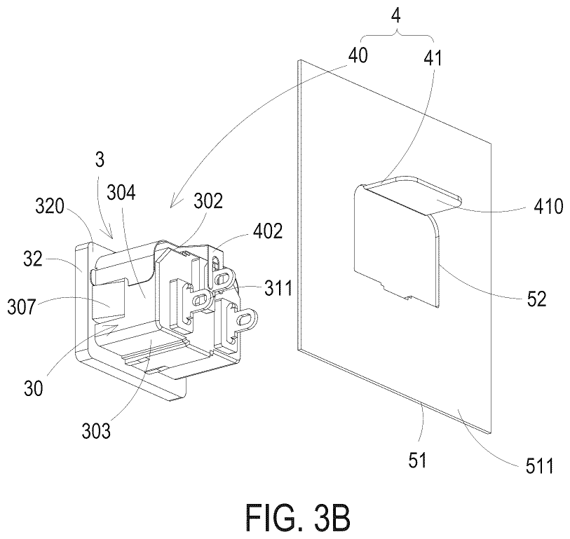

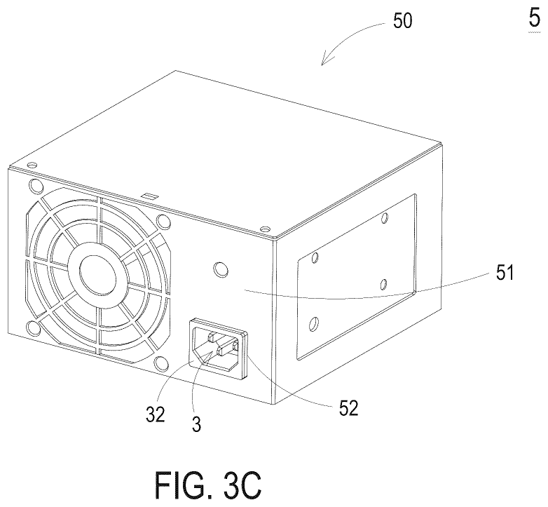

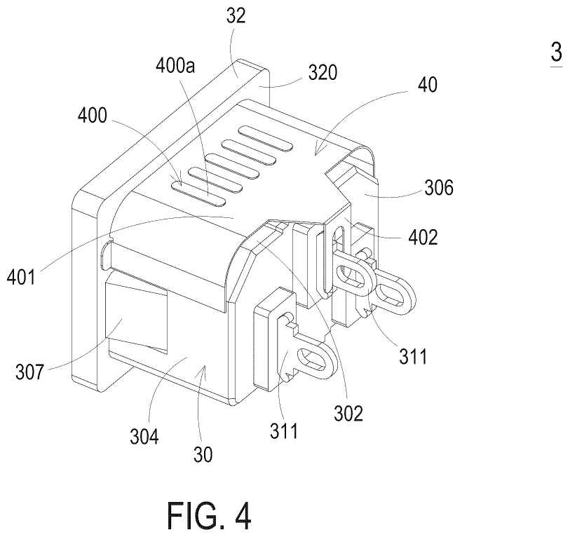

FIG. 3A is a schematic perspective view illustrating a socket and a housing of a power supply according to a first embodiment of the present disclosure. FIG. 3B is a schematic rear view illustrating the socket and the housing of the power supply of FIG. 3A. FIG. 3C is a schematic perspective view illustrating the power supply according to the first embodiment of the present disclosure. FIG. 4 is a schematic perspective view illustrating the socket of FIG. 3B. Please refer to FIGS. 3A, 3B, 3C and 4, in this embodiment, the socket 3 is for using in a power supply 5. The socket 3 comprises a main body 30, a shielding layer 40 and a conductive component 31. The main body 30 is a square box structure and has a first opening 300 and a receptacle 301. The receptacle 301 is communicated to the first opening 300. The shielding layer 40 covers at least one side 302 of the main body 30 and has at least one protrusion 400. The conductive component 31 passes through the main body 30 and is partially disposed in the receptacle 301. When the main body 30 is disposed in the housing 50 of the power supply 5, the at least one protrusion 400 is in contact with at least one contact plate 41 which is bent and extended inwardly from the housing 50.

Please refer to FIGS. 3A, 3B and 3C. As shown in FIG. 3A, the socket 3 further includes a fixing frame 32, the fixing frame 32 connects to the main body 30, arranged around the first opening 300, and has an inner surface 320. The conductive component 31 includes a first terminal 310 and a second terminal 311 (as shown in FIG. 3B), wherein the first terminal 310 is arranged in the receptacle 301 of the main body 30. In the embodiment, the receptacle 301 is for a corresponding plug (not shown) plugging in. When the plug is plugged in the receptacle 301, the conductive component 31 can electrically couple with a conductive terminal (not shown) of the plug through the first terminal 310. In the embodiment, each protrusion 400 of the shielding layer 40 has a first contact surface 400a. As shown in FIG. 3C, the at least one contact plate 41 of the housing 50 of the power supply 5 is a plate bent and extended toward an inner surface 511, and each contact plate 41 has a second contact surface 410. In other words, in the embodiment, the contact plate 41 is perpendicular to the inner surface 511 of the housing 50, but not limited thereto. In some embodiments, the electromagnetic shielding assembly 4 is composed of the shielding layer 40 and at least one contact plate 41, but not limited thereto. As shown in FIG. 3B, the number of the at least one contact plate 41 is one, which means there is only one second contact surface 410 in this embodiment. The number of the contact plate 41 and the number of the first contact surface 400a of the protrusion 400 are not limited to the above embodiments. Moreover, as shown in FIGS. 3B and 3C, the housing 50 of the power supply 5 is composed of a plurality of sides. And, a second opening 52 is formed on a back plate 51 of the housing 50. As mentioned above, the at least one contact plate 41 is a plate bent inwardly from the back plate 51 along one edge of the second opening 52, but not limited thereto. When the main body 30 of the socket 3 passes through the second opening 52 on the back plate 51 of the power supply 5, and is disposed in the housing 50 of the power supply 5, the at least one first contact surface 400a of the at least one protrusion 400 of the shielding layer 40 simultaneously contacts and abuts the second contact surface 410 of the contact plate 41 of the housing 50. At the same time, the fixing frame 32 of the socket 3 is correspondingly abutted the outer surface 510 of the back plate 51 of the housing 50, so that the socket 3 is correspondingly engaged with the second opening 52 of the back plate 51. In other words, the inner surface 320 of the fixed frame 32 of the socket 3 is in contact with the outer surface 510 of the back plate 51 of the housing 50. In other embodiments, the second opening 52 can be arranged on other plates of the housing 50, such as the side plates, these arrangements can be adjustable according the practical requirement, and not limited thereto.

Please refer to FIG. 4. As shown in FIG. 4, the main body 30 of the socket 3 is a square box structure, and includes a first side 302, a second side 303 (as shown in FIG. 3A), a third side 304, a fourth side 305 (as shown in FIG. 3A) and a fifth side 306. In the embodiment, the first side 302 is opposite to the second side 303 and is connected to the third side 304 and the fourth side 305, the third side 304 is opposite to the fourth side 305 and is connected to the first side 302 and the second side 303. One edges of the first side 302, the second side 303, the third side 304 and the fourth side 305 are respectively connected to the fixed frame 32 and perpendicular to the inner surface 320 of the fixed frame 32, and the opposite edges of the first side 302, the second side 303, the third side 304 and the fourth side 305 are respectively connected to the fifth side 306. In the embodiment, the fifth side 306 is arranged to face the first opening 300, but not limited thereto. As shown in FIG. 3A and FIG. 4, the conductive component 31 of the socket 3 includes a first terminal 310 and a second terminal 311, wherein the second terminal 311 is opposite to the first terminal 310, and the first terminal 310 is arranged in the receptacle 301 of the main body 30, and the second terminal 311 correspondingly penetrates the fifth side 306 of the main body 30, and is protruded on the fifth side 306.

In this embodiment, as mentioned above, the electromagnetic shielding assembly 4 is composed of the shielding layer 40 and at least one contact plate 41, which means the shielding layer 40 and the contact plate 41 are both made of a metal material, but not limited thereto. As shown in FIG. 4, the shielding layer 40 covers the first side 302 of the main body 30, but not limited thereto. In other embodiments, the shielding layer 40 may cover the first side 302, the second side 303, the third side 304 and the fourth side 305 of the main body 30, the arrangements of the shielding layer 40 are not limited to above embodiments, and can be adjustable according the practical requirement. In this embodiment, the at least one protrusion 400 is a plurality of elongated protruding ribs, and is disposed on a first surface 401 of the shielding layer 40. That is, the plurality of protrusions 400 are correspondingly disposed on the shielding layer 40 covering the first side 302. In the embodiment, the shielding layer 40 further has an extension portion 402, and the extension portion 402 is electrically coupled with the second terminal 311 of the conductive component 31 of the socket 3. Moreover, each of the protrusions 400 has a first contact surface 400a. Since each of the protrusions 400 of the embodiment is an elongated protruding rib, each first contact surface 400a is also an elongated flat contact surface. Taking this embodiment as an example, the shielding layer 40 is provided with five protrusions 400, so that five elongated first contact surfaces 400a is provided. When the five elongated first contact surfaces 400a are in flat contact with the second contact surface 410 of the contact plate 41 of the housing 50 (as shown in FIG. 3B), multi-point contact and a larger contact area are achieved. Consequently, even if the plug 3 is pushed to plug or pull out multiple times by external force, causing the it is slightly loose or sliding, the socket 3 can still contact the housing 50 stably, due to the large area of multi-point contact means between the plurality of protrusions 400 on the shielding layer 40 of the electromagnetic shielding assembly 4 and the second contact surfaces 410 of the contact plate 41. Consequently, the electromagnetic interference (EMI) can be conducted outwardly through the housing 50, so that the beneficial of effectively shielding the electromagnetic interference, increasing the stability, performance and service life of the product are achieved.

In other embodiments, as shown in FIG. 4, the socket 3 further includes a pair of latching portions 307, which are disposed on the third side 304 and the fourth side 305, respectively, and not limited thereto. In the embodiment, the latching portion 307 is a latching structure with inclined surface. When the socket 3 passes through the second opening 52 on the back plate 51 of the power supply 5, the socket 3 is engaged and positioned in the second opening 52 of the back plate 51 through the inclined surface of the latching portion 307 sliding inwardly along the edge of the second opening 52. The types, the number, and the arrangements of the latching portion 307 can be adjustable according the practical requirement, and not limited thereto.

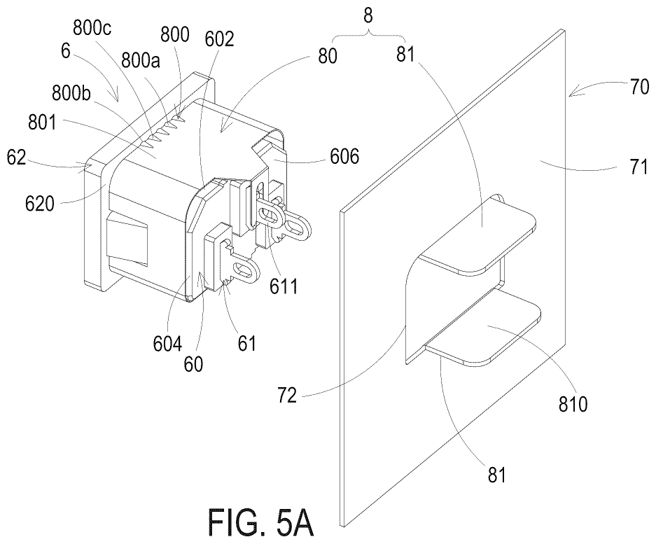

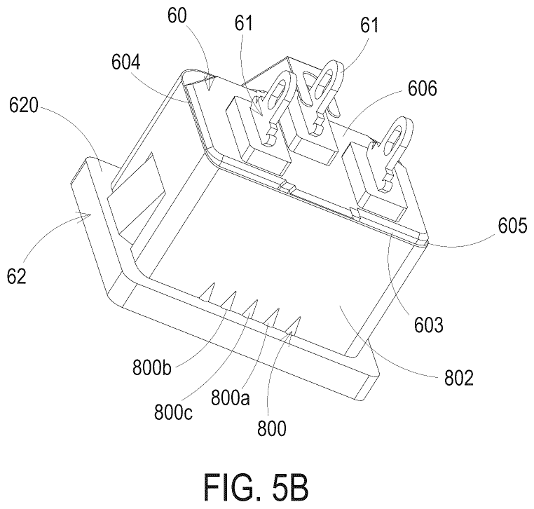

Please refer to FIGS. 5A and 5B. FIG. 5A is a schematic perspective view illustrating a socket and a housing of a power supply according to a second embodiment of the present disclosure. FIG. 5B is a schematic bottom view illustrating the socket of FIG. 5A. As shown in FIG. 5A, the socket 6 also comprises a main body 60, a shielding layer 80, a conductive component 61 and a fixing frame 62. Similar to the previous embodiment, the main body 60 is also a square box structure and has a first opening (not shown) and a receptacle (not shown) in communication with each other. The fixing frame 62 is in connection with the main body 60, and is arranged around the first opening. In the embodiment, the main body 60 includes a first side 602, a second side 603 (as shown in FIG. 5B), a third side 604, a fourth side 605 (as shown in FIG. 5B) and a fifth side 606. In this embodiment, the structures and the arrangements of the first opening, the receptacle, the first side 602, the second side 603, the third side 604, the fourth side 605 and the fifth side 606 are the same as those of the previous embodiment and will not be described in details herein. In the embodiment, the shielding layer 80 covers the first side 602, the second side 603, the third side 604 and the fourth side 605 of the main body 60, and has at least one protrusion 800. The conductive component 61 passes through the main body 60 and is partially disposed in the receptacle. When the main body 60 is disposed in the housing 70 of the power supply, the at least one protrusion 800 is in contact with at least one contact plate 81 which is bent and extended inwardly from the housing 70. In the embodiment, the type and the structure of the power supply are the same as the previous embodiment, which includes the housing 70 made of a plurality of plates, and the housing 70 also includes a back plate 71, and a second opening 72 is formed on the back plate 71 for the socket 6 correspondingly passing through.

Similar to the previous embodiment, the electromagnetic shielding assembly 8 is composed of the shielding layer 80 and the contact plate 81 of the housing 70, but not limited thereto. While in the embodiment, as shown in FIGS. 5A and 5B, the shielding layer 80 completely covers the first side 602, the second side 603, the third side 604 and the fourth side 605 of the main body 60 of the socket 6, and not limited thereto. Moreover, in the embodiment, the at least one protrusion 800 is a plurality of triangular ribs disposed on the first surface 801 and the second surface 802 (as shown in FIG. 5B) of the shielding layer 80, which means the plurality of protrusions 800 are correspondingly disposed on the shielding layer 80 covering the first side 602 and the second side 603 (as shown in FIG. 5B). In the embodiment, each of the protrusions 800 has a first contact surface 800a. Since each of the protrusions 800 of the embodiment is a triangular rib, each the first contact surface 800a is a curved triangular contact surface. Each of the protrusions 800 has a side 800b and a curved inclined surface 800c. The side 800b is correspondingly connected to an inner surface 620 of the fixing frame 62 of the socket 6, and the inclined surface 800c is diagonally extended from the inner surface 620 to the first surface 801 and the second surface 802 of the shielding layer 80. In other words, in the embodiment, each of the protrusions 800 not only protrudes on the first surface 801 and the second surface 802 of the shielding layer 80, but also is connected to the inner surface 620 of the fixing frame 62 at one side.

As shown in FIGS. 5A and 5B, due to the protrusions 800 are arranged on the first surface 801 covering on the first side 602 and the second surface 802 covering on the second side 603 at the same time. The number of the contact plate 81 of the housing 70 is two, and the position of the two contact plates 81 are also corresponding to the first side 602 and the second side 603, which means the contact plates 81 are provided on the upper and lower sides, respectively. In the embodiment, as shown in FIG. 5A, the two contact plates 81 are two plates bent inwardly from the back plate 71 along the upper and lower edges of the second opening 72, but not limited thereto. Moreover, there are five protrusions 800 arranged on the first surface 801 of the shielding layer 80 covering the first side 602, and there are also five protrusions 800 arranged on the second surface 802 of the shielding layer 80 covering the second side 602. Consequently, a total of ten first contact surfaces 800a with curved triangular contact surfaces are provided. When the ten protrusions 800 are in contact with the second contact surface 810 of the upper and lower contact plates 81, multi-point contact and a larger contact area are achieved. Accordingly, the covering region of the shielding layer 80 of the electromagnetic shielding assembly 8, the number, the appearance, the types, and the arrangements of the protrusions 800 and the contact plates 81 are not limited to these embodiments, which can be can be adjustable according the practical requirement. Consequently, even if the plug 6 is pushed to plug or pull out multiple times by external force, causing the it is slightly loose or sliding, the socket 6 can still contact the housing 70 stably, due to the large area of multi-point contact means between the plurality of protrusions 800 on the shielding layer 80 of the electromagnetic shielding assembly 8 and the second contact surfaces 810 of the contact plates 81. Consequently, the electromagnetic interference (EMI) can be conducted outwardly through the housing 70, so that the beneficial of effectively shielding the electromagnetic interference, increasing the stability, performance and service life of the product are achieved.

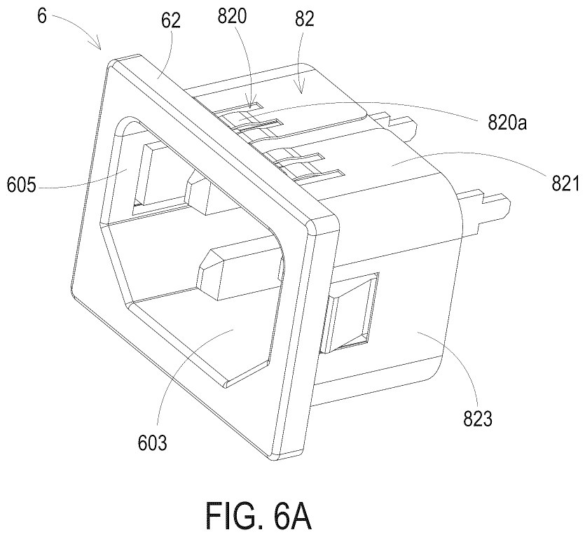

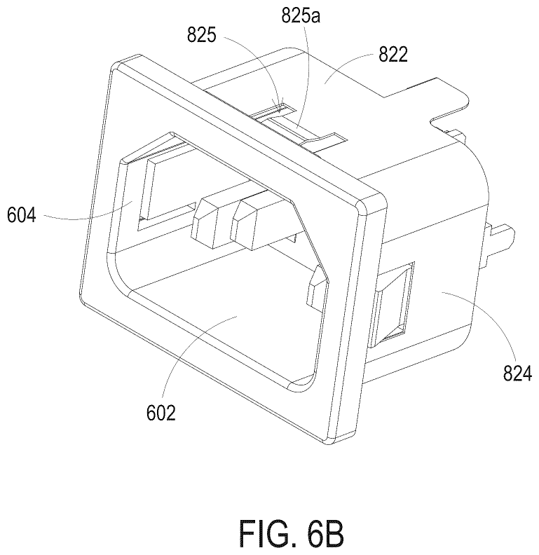

Please refer to FIGS. 6A and 6B. FIG. 6A is a schematic perspective view illustrating a socket according to a third embodiment of the present disclosure. FIG. 6B is a schematic bottom view illustrating the socket of FIG. 6A. In this embodiment, the electromagnetic shielding assembly 8 can share the at least one contact plate 81 of the housing 70 of the previous embodiment, and the socket 6 also uses the same socket as the previous embodiment, which means the socket 6 also includes the same main body 60, the same conductive component 61 and the same fixed frame 62. Since the structures of the socket 6 are the same as those of the previous embodiment, it will not be described in details herein. In this embodiment, the electromagnetic shielding assembly 8 is composed of the shielding layer 80 and the contact plate 81 of the housing 70, while in this embodiment, the types of the protrusions 820 of the shielding layer 82 are different from the previous embodiment. In the embodiment, the shielding layer 82 completely covers the first side 602, the second side 603, the third side 604 and the fourth side 605 of the main body 60 of the socket 6, and not limited thereto. In other words, the first surface 821 of the shielding layer 82 covers the first side 602, the second surface 822 of the shielding layer 82 covers the second side 603, the third surface 823 of the shielding layer 82 covers the third side 604, and the fourth surface 824 of the shielding layer 82 covers the fourth side 605, respectively. In this embodiment, as shown in FIG. 6A, the at least one protrusion 820 is at least one elastic piece disposed on the first surface 821 of the shielding layer 82. The top of the elastic piece of each protrusion 820 has a first contact surface 820a. In some embodiments, the first contact surface 820a can be a slightly curved surface and can be in contact with its corresponding contact plate 81. In other embodiments, the first contact surface 820a can also be a flat surface and can be in flat contact with its corresponding contact plate 81, so that multi-point contact and a larger contact area are achieved. Consequently, the beneficial of stable contact and improving shielding the electromagnetic interference are achieved.

In addition, as shown in FIG. 6B. In this embodiment, the at least one protrusion 825 disposed on the second surface 822 of the shielding layer 82 can be but not limited to be a single elastic piece. Although it is a single elastic piece, compared with the protrusions 820 shown in FIG. 6A, the protrusion 825 is a larger elastic piece structure, which means there is a wider first contact surface 825a at the top of the elastic piece structure. Consequently, when the protrusion 825 contacts and abuts the contact plate 81 of the housing 70, it can also increase the contact area, so that the beneficial of improving shielding the electromagnetic interference and stable contact are also achieved. Accordingly, the at least one protrusion 820, 825 can be arranged on different surface, such as the first surface 821 and the second surface 822, respectively. That is to say, the type, the number and the arrangement of the protrusion arranged on each surface can be adjustable according the practical requirement, and not limited thereto.

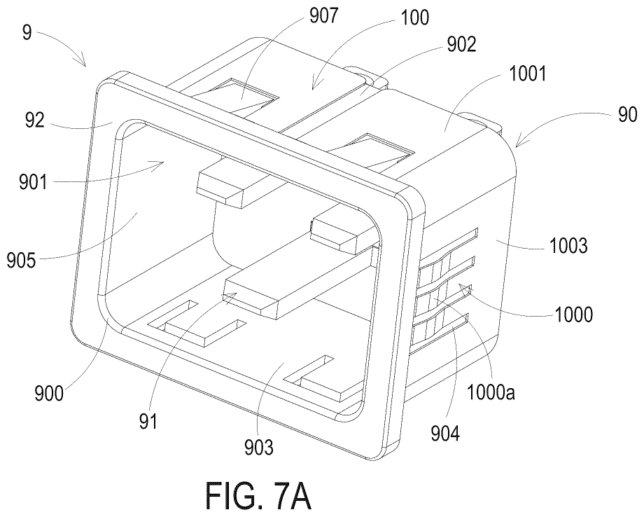

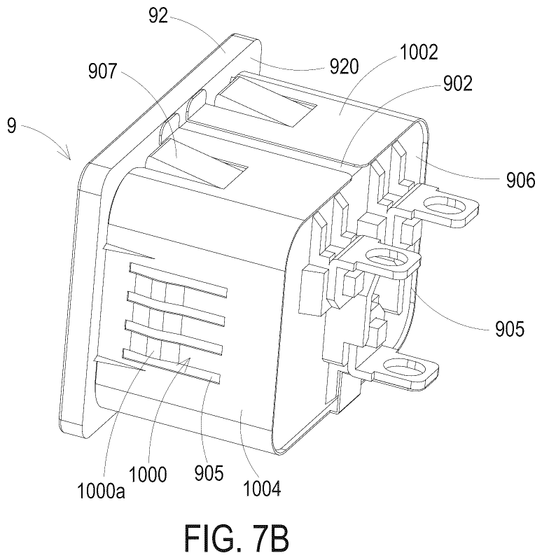

Please refer to FIGS. 7A and 7B. FIG. 7A is a schematic perspective view illustrating a socket according to a fourth embodiment of the present disclosure. FIG. 7B is a schematic rear view illustrating the socket of FIG. 7A. In this embodiment, the socket 9 is similar to the socket of the previous embodiment, although there is slightly different in its appearance, while the structures and the arrangement are the same. The socket 9 also includes the main body 90, the conductive component 91 and the fixed frame 92. The main body 90 is a square box structure and has a first opening 900 and a receptacle 901 in communication with each other, and the fixing frame 92 is connecting to the main body 90, and arranged around the first opening 900. The conductive component 91 passes through the main body 90 correspondingly and partially disposed in the receptacle 901. In the embodiment, the main body 90 includes a first side 902, a second side 903, a third side 904, a fourth side 905 and a fifth side 906. One edges of the first side 902, the second side 903, the third side 904 and the fourth side 905 are respectively connected to the fixed frame 92 and perpendicular to the inner surface 920 of the fixed frame 92. In the embodiment, since the structures and the arrangements of the first opening 900, the receptacle 901, the first side 902, the second side 903, the third side 904, the fourth side 905 and the fifth side 906 are the same as those of the previous embodiment, it will not be described in details herein. In the embodiment, the shielding layer 100 completely covers the first side 902, the second side 903, the third side 904 and the fourth side 905 of the main body 909, and has at least one protrusion 1000. In other words, the first surface 1001 of the shielding layer 100 covers the first side 902, the second surface 1002 of the shielding layer 100 covers the second side 903, the third surface 1003 of the shielding layer 100 covers the third side 904, and the fourth surface 1004 of the shielding layer 100 covers the fourth side 905, respectively. When the main body 90 is corresponding disposed in the housing (not shown) of the power supply (not shown), the at least one protrusion 1000 is in contact with at least one contact plate (not shown) which is bent and extended inwardly from the housing.

In this embodiment, the types and the arrangements of the protrusions 1000 of the shielding layer 100 are different from the previous embodiment. As shown in FIGS. 7A and 7B, the at least one protrusion 1000 is a plurality of elastic pieces. The plurality of elastic pieces are disposed on the third surface 1003 and the fourth surface 1004 of the shielding layer 100, respectively. In other words, they are correspondingly arranged on the two opposite sides of the main body 90, that is, the third side 904 and the fourth side 905. In the embodiment, the socket 9 further includes a plurality of latching portions 907, which are respectively disposed on the first side 902 and the second side 903 of the main body 90, and not limited thereto. In the embodiment, the top of each elastic piece of the protrusions 1000 is a first contact surface 1000a, and each first contact surface 1000a can contact and abut the corresponding contact plate (not shown). In the embodiment, in order to cooperate with the at least one protrusion 100, the contact plate are two plates bent inwardly from the back plate (not shown) along the left and right edges of the second opening (not shown), but not limited thereto. Moreover, of the shielding layer 100, there are three protrusions 1000 arranged on the third surface 1003 and there are three protrusions 1000 arranged on the fourth surface 1004, respectively. Consequently, there are six elastic pieces in total, and a total of six first contact surfaces 1000a are provided. When the six protrusions 1000 are in contact with the second contact surface (not shown) of the left and right contact plates (not shown), multi-point contact and a larger contact area are achieved. Accordingly, the covering region of the shielding layer 100 of the electromagnetic shielding assembly, the number, the appearance, the types, and the arrangements of the protrusions 1000 are not limited to these embodiments, which can be can be adjustable according the practical requirement. Consequently, even if the plug 9 is pushed to plug or pull out multiple times by external force, causing the it is slightly loose or sliding, the socket 9 can still contact the housing stably, due to the large area of multi-point contact means between the plurality of protrusions 1000 on the shielding layer 100 and the second contact surfaces of the contact plates. Consequently, the electromagnetic interference (EMI) can be conducted outwardly through the housing, so that the beneficial of effectively shielding the electromagnetic interference, increasing the stability, performance and service life of the product are achieved.

From the above descriptions, the present disclosure provides a socket and an electromagnetic shielding assembly. There is at least one protrusion arranged on the shielding layer of the socket, and each protrusion has a first contact surface. Through the contact manners between the at least one protrusion of the first contact surface and at least one second contact surface of the contact plate of the housing of the power supply, multi-point contact and a larger contact area are achieved. Consequently, the efficiency of the electromagnetic interference (EMI) conducted outwardly is increased. Moreover, the electromagnetic shielding assembly is composed of the shielding layer and at least one contact plate. Consequently, through the contact manners between the shielding layer of the socket and the contact plate bent inwardly from the housing of the power supply, so as to achieve electromagnetic shielding and conduction effects. At the same time, the contact strength between the shielding layer and the contact plate is enhanced, and the poor contact problem of the prior art can be solved, so that the beneficial of increasing the stability, performance and service life of the product are achieved.

While the disclosure has been described in terms of what is presently considered to be the most practical and preferred embodiments, it is to be understood that the disclosure needs not be limited to the disclosed embodiment.

What is claimed is:

1. A socket for using in a power supply, the power supply including a housing and at least one contact plate, the at least one contact plate being bent and extended inwardly from the housing for contacting with the socket to form an electromagnetic shielding assembly, and the socket comprising:
a main body having a first opening and a receptacle, wherein the receptacle is communicated with the first opening;
a shielding layer covering at least one side of the main body and having at least one protrusion for contacting the at least one contact plate; and
a conductive component passing through the main body and partially disposed in the receptacle.

2. The socket according to claim 1, wherein the at least one protrusion is a plurality of elongated protruding ribs, and is disposed on at least one surface of the shielding layer.

3. The socket according to claim 1, wherein the at least one protrusion is at least one elastic piece, and is disposed on at least one surface of the shielding layer.

4. The socket according to claim 1, wherein the socket further includes a fixing frame which connects to the main body and is arranged around the first opening, and has an inner surface, and when the main body is correspondingly disposed in the housing of the power supply, the fixed frame corresponds to arrange on an outer surface of the housing.

5. The socket according to claim 4, wherein the main body includes a first side, a second side, a third side, a fourth side and a fifth side, wherein the first side is opposite to the second side and is connected to the third side and the fourth side, the third side is opposite to the fourth side and is connected to the first side and the second side, wherein one edges of the first side, the second side, the third side and the fourth side are respectively connected to the fixed frame and perpendicular to the inner surface of the fixed frame, and the opposite edges of the first side, the second side, the third side and the fourth side are respectively connected to the fifth side, and the fifth side is arranged to face the first opening.

6. The socket according to claim 5, wherein the conductive component includes a first terminal and a second terminal, wherein the first terminal is arranged in the receptacle, and the second terminal correspondingly penetrates the fifth side of the main body, and is protruded on the fifth side.

7. The socket according to claim 5, wherein the shielding layer covers the first side of the main body, and the at least one protrusion is correspondingly disposed on the shielding layer.

8. The socket according to claim 5, wherein the shielding layer covers the first side, the second side, the third side and the fourth side of the main body, and the at least one protrusion is correspondingly disposed on the shielding layer covering the first side and the second side.

9. The socket according to claim 1, wherein the shielding layer is made of a metal material.

10. The socket according to claim 9, wherein the at least one protrusion includes a plurality of triangular ribs disposed on at least one surface of the shielding layer, wherein one side of each triangular rib is correspondingly connected to the inner surface of the fixing frame, and a inclined surface of each triangular rib is diagonally extended from the inner surface to the at least one surface of the shielding layer.

11. An electromagnetic shielding assembly, comprising:
a shielding layer covering at least one side of a main body of a socket, and having at least one protrusion, wherein each protrusion has a first contact surface; and
at least one contact plate being bent and extended inwardly from a housing of a power supply,
wherein when the socket is corresponding disposed in the housing of the power supply, the at least one first contact surface of the at least one protrusion is in contact with at least one second contact surface of the at least one contact plate.

12. The electromagnetic shielding assembly according to claim 11, wherein the at least one second contact surface is perpendicular to an inner surface of the housing.

13. The electromagnetic shielding assembly according to claim 11, wherein the at least one protrusion is a plurality of elongated protruding ribs disposed on at least one surface of the shielding layer.

14. The electromagnetic shielding assembly according to claim 11, wherein the at least one protrusion is at least one elastic piece disposed on at least one surface of the shielding layer.

15. The electromagnetic shielding assembly according to claim 11, wherein the at least one protrusion is a plurality of triangular ribs disposed on at least one surface of the shielding layer, wherein one side of each triangular rib is correspondingly connected to an inner surface of a fixing frame of the socket, and a inclined surface of each triangular rib is diagonally extended from the inner surface to the at least one surface of the shielding layer.
